(19) United States
(12) Patent Application Publication
(10) Pub. No.: US 2020/0326611 A1
(43) Pub. Date: Oct. 15, 2020

(54) Three Axis Stabilizer Using One Motor and Configurable Mounting

(71) Applicant: Lancelot Gelas, Santa Monica, CA (US)

(72) Inventor: Lancelot Gelas, Santa Monica, CA (US)

(21) Appl. No.: 16/383,487

(22) Filed: Apr. 12, 2019

(51) Int. Cl. G03B 17/56; G03B 17/08; F16M 11/12; F16M 13/04

(52) U.S. Cl. CPC G03B 17/561; G03B 17/08; H02K 21/22; F16M 13/04; F16M 11/126

(57) ABSTRACT

A three axis stabilizer with one motor and configurable mounting is disclosed. The invention being comprised of six main components. A first component being an L-shaped camera mount configured to receive popular action cameras; a second component being a stabilizer mount allowing it to be affixed to a user or tripod; a third component being a stabilizer to control roll pitch and yaw individually during filming; a fourth part being a microprocessor; a fifth part being transitory memory to store programs and a sixth part being a single, electric motor that drives the stabilizer. An object of the invention is to reduce the overall size normally associated with three-motor, gimbal stabilization systems. Having a single motor, allows a user to manually position the camera on the various axis's to correct roll, pitch and yaw on a single axis—depending on the scene.

### CROSS-REFERENCE TO RELATED APPLICATIONS

This application claims the benefit of U.S. Provisional Patent Application No. 62/516,571.

### BACKGROUND

A class of cameras, referred to herein as action cameras, has emerged for use in sports activities. The current category leader is GOPRO, headquartered in San Mateo, Calif., which manufactures and markets a range of action cameras. These cameras capture video as well as still images.

Action cameras are typically mounted to a device or to the body of a human user during the performance of high speed activities such as bicycling, skiing, surfing, and skateboarding, Typically, during the performance of these activities the individual and any required sports equipment, such as a surfboard, skateboard or bicycle, moves or wobbles considerably. Consequently, when a video or image is captured during the performance of such activity the resulting video can be shaky or wobbly, which may detract from the enjoyment of watching the resulting video, As a consequence, image stabilizers have been invented to compensate for the movement of the action camera to reduce the shake.

Prior art image stabilizers for action cameras, also referred to as gimbal stabilizers, provide stabilization in all three dimensions, roll, pitch and yaw. simultaneously using three motors, each of which performs stabilization in one axis. Thus, prior art image stabilizers have one motor each for the pitch dimension, the roll dimension and the yaw dimension. For example, GOPRO provides a 3-axis stabilizer named GO PRO KARMA GRIP. Another 3-axis stabilizer is the FEIYU G3 ULTRA 3-AXIS HANDHELD GIMBAL, by GUILIN FEIYU TECHNOLOGY, located in Guilin, China.

A disadvantage of prior art 3-axis stabilizers for action cameras is that because they incorporate three motors they are bulky, and heavy. As a consequence, prior art stabilizers cannot be readily mounted on a user's helmet or chest or on equipment, such as skis or bicycles, during the performance of a sports activity. Typically, they are mounted on a stick or staff that is held by the user.

Thus, it would be desirable for a stabilizer used in conjunction with an action camera to have reduced weight and size so that it can mount directly to a user's helmet, or to the body or to an item of sports equipment during the performance of a sports activity.

It with respect to these considerations and others that the present invention has been made.

### SUMMARY OF THE DESCRIPTION

Various embodiments of the subject invention pertain to a stabilization device for action cameras that has reduced size and weight enabling it to be mounted to a user's helmet or body or to an item of sports equipment during performance of a sporting activity. The stabilizer can be configured to stabilize in any of the three spatial dimensions, roll, pitch, and yaw. The subject invention incorporates only a single motor. Thus, it stabilizes the camera in one axis at a time, as configured by the user.

The invention provides two modes: a stabilizer mode, and a moving time-lapse mode. The stabilizer mode stabilizes an action camera in one axis. The time-lapse mode rotates the camera from a starting or entry point to a finishing or exit point over a user configurable time period.

In certain embodiments, the invention is waterproof. As such it is designed to include O-rings, a closed or sealed motor and other design elements to prevent water from entering the electronics or motor compartments.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to tire following Detailed Description of the Preferred Embodiment, which is to be read in association with the accompanying drawings, wherein:

FIGS. 1A-B are isometric views of one embodiment of a stabilizer for an action camera.

FIGS. 2A-B are exploded views of one embodiment of the components of the stabilizer.

FIGS. 3A-C illustrate the configuration of an action camera and the stabilizer for each of the three spatial dimensions.

FIGS. 4A-4B illustrate the stabilizer 1 with camera mount 5 that is configured to stabilize a camera in the roll axis.

FIGS. 4C and 4D illustrate stabilizer 1 with a modified camera mount 5A that is configured to stabilize a camera in the pitch axis

FIGS. 5A-B illustrate two modes provided by the stabilizer, a stabilization mode and a moving time-lapse mode.

FIG. 6A is an exploded view of one embodiment of the components of a motor used in the stabilizer.

FIG. 6B is an isometric view of one embodiment of the motor used in the stabilizer.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Action camera—a camera, such as that provided by GOPRO, NIKON and other companies, that is intended for use in sporting activities. The primary characteristics for the purposes of the subject invention are that (1) an action camera is small enough to mount on a user's helmet or chest, or onto an item of sports equipment such as a skateboard, surfboard, bicycle, without disturbing the performance of the user, (2) it generates digital video images and in some cases digital still images, and (3) it has a mechanism for mounting to a mounting device that is fixed on the user's helmet or body or to an item of sporting equipment. Typically, the action camera incorporates a male (or female) mounting element and the mounting device that is fixed to the user's helmet, apparel or equipment has a corresponding female (male) element.

User—a person using a camera, mobile device or other device where the subject invention is attached to the device and is performing image stabilization. Examples herein are directed towards a user being engaged in a sports activity and using an action camera; but the invention is not limited to action cameras and sports activities.

Three axes—the three spatial axes are referred to herein as roll (longitudinal axis), pitch (lateral axis), yaw (vertical axis). These arc adopted from the three symmetry axes of a plane, as described in an article in WIKIPEDIA which can be found at: https://en.wikipedia.org/wiki/Aircraft_principal_axes.

### Generalized Operation

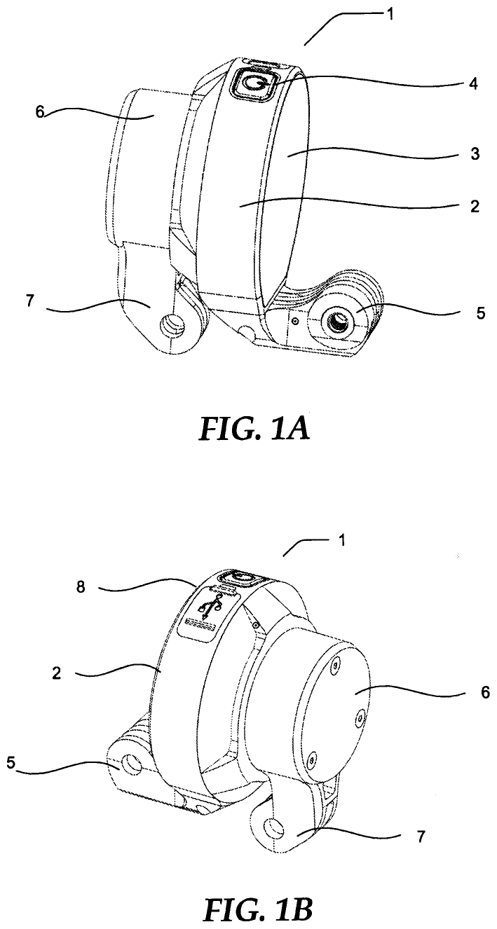

The operation of certain aspects of the invention is described below with respect to FIGS. 1-4.

FIGS. 1A-B are isometric views of one embodiment of a stabilizer 1 for an action camera. Stabilizer 1 includes an enclosure 2 with a front face 2 and a camera mount 5 that attaches to enclosure 2. In certain embodiments, camera mount 5 is the female portion of a mount where a camera (not depicted) has the male portion. Thus, stabilizer 1 and a camera connect via camera mount 5. Stabilizer 1 further includes a motor 6 whose rotational motion stabilizes an attached camera in one axis. Stabilizer 1 attaches to a helmet, item of sporting equipment or another external element via a stabilizer mount 7. As depicted, stabilizer mount 7 is a male mounting element and camera mount 5 is a corresponding female element. This enables stabilizer 1 to mount to any device with a GOPRO female mounting clement. Alternatively, stabilizer mount 7 can be of a different type than GOPRO, enabling it to mount to other types of equipment. Generally, camera mount 5 and stabilizer mount 7 can have any type of connection without departing from the scope and spirit of the subject invention.

Stabilizer 1 further includes a user control 4 and a power interface 8. In certain embodiments control 4 is a push button. The number of presses and the duration of the presses on control 4 can be determined by stabilizer 1 and used to activate various functions. In other embodiments, other types of controls may be used. As illustrated, power interface 8, shown in a covered configuration, is a USB type interface. A user would press power interface 8 to uncover the actual interface and insert a USB cable, USB interface may be used to receive power or to transmit and receive data signals.

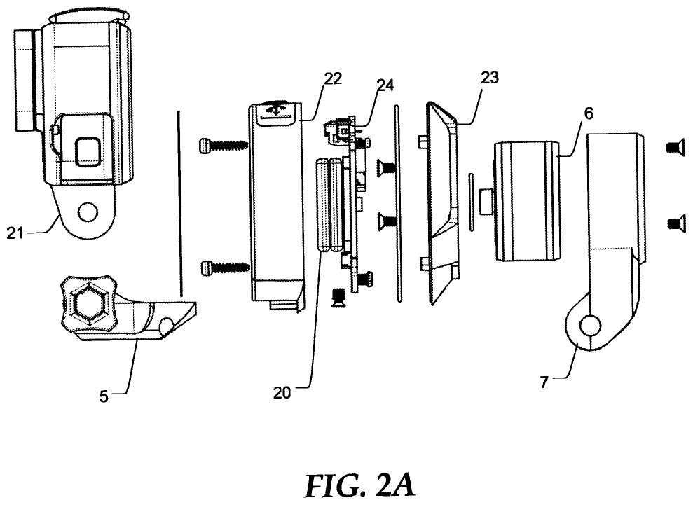

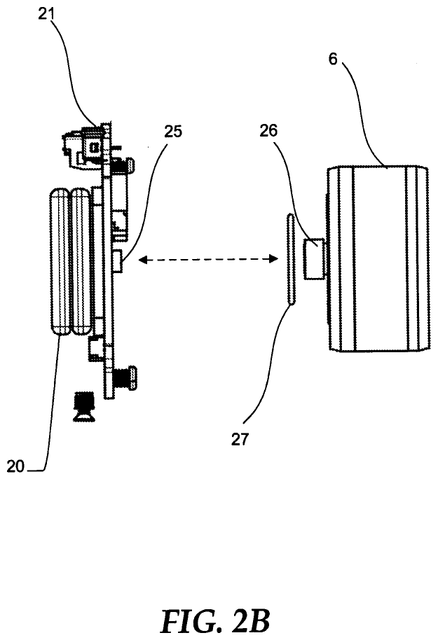

FIG. 2A is an exploded view of one embodiment of the components of stabilizer 1 that mounts to a camera 20. Stabilizer 1 uses mounting hardware referred as camera mount 21, which is typically provided by the camera manufacturer. In this example configuration, camera 20 is shown as including a GOPRO style male connector that in turn connects to a female camera mount 5 which attaches to stabilizer 1. Stabilizer I includes four major components: camera mount 5, enclosure 2, motor 6, and stabilizer mount 7. Enclosure 2, which has a front enclosure 22 and a back enclosure 23, houses electronic elements including a battery 20, processor, non-transitory memory for storing data, and program instructions. In one embodiment, the electronics elements are implemented as a printed circuit board assembly, PCBA 24. PCBA 24 includes a processor and non-transitory memory that stores data and program instructions. PCBA 24 also includes an inertial measurement unit (IMU), which is electronic device, implemented in certain embodiments as one or more semiconductor chips, that measures and reports the angular position or change in angular position of stabilizer 1, using a combination of accelerometers and gyroscopes, and, in some cases, magnetometers. As an example, if a user has an action camera with stabilizer 1 attached to their helmet while bicycling and they roll to the right or left relative to the longitudinal direction of their motion then the IMU will identify this change in position and report it to the processor. The processor in turn will send instructions to motor 6 to move an equal amount in the opposite direction, i.e. to correct for the roll movement and thus stabilize the action camera in the roll axis.

Battery 20 is illustrated as including two rectangular battery cells. However, it may include more or less battery cells. In certain embodiments, battery 20 is a lithium ion type of battery.

Generally, stabilizer mount 7 connects to a corresponding mounting element attached the user's helmet, apparel or to an item of equipment and moves with the user or item of equipment. Motor 6 on the other hand rotates around its axis in the direction opposite from the user's movement to compensate for the user's movement. Stabilizer mount 7 provides the same mounting interface as camera mount 21, thus enabling stabilizer 1 to provide the same type of attachment as camera 20. Stabilizer mount 7 and camera mount 5 can be replaced with other types of mounting hardware; thus, together they form an interchangeable mounting solution that works with inter alia action cameras, other types of cameras and video cameras, and mobile devices.

FIG. 2B is a detailed view of a portion of FIG. 2A that illustrates the operation of an encoder 25 and a magnet 26 clement that together enable the processor to precisely control the movement of motor 6. Encoder 25 is a magnetic position sensor that converts the rotary movement or angular position of motor 6 into a digital signal by reading the magnetic field of magnet 26, which is connected to motor 6. An example of a commercially available device that implements the function of encoder 25 is the AS5600 Position Sensor provided by AMS, headquartered in Austria. Information about the AS5600 can be found at the following website; http://ams.com/eng/Products/Magnetic-Position-Sensors/Angle-Position-On-Axis/AS5600

Magnet 26, is connected to the Shaft 68 of the Motor 6. Encoder 25 reads the angular position of magnet 26 to obtain information about the position of the motor and then provides it to the processor, which, in turn, generates signals to motor 6 to improve stabilization. There is no contact between encoder 25 and magnet 26.

Also, depicted in FIG. 2B is O-ring 27, which creates a water-tight seal between motor 6 and back enclosure 22. Generally, stabilizer 1 is waterproof, thus every interface and every moving part must be sealed to prevent water intrusion.

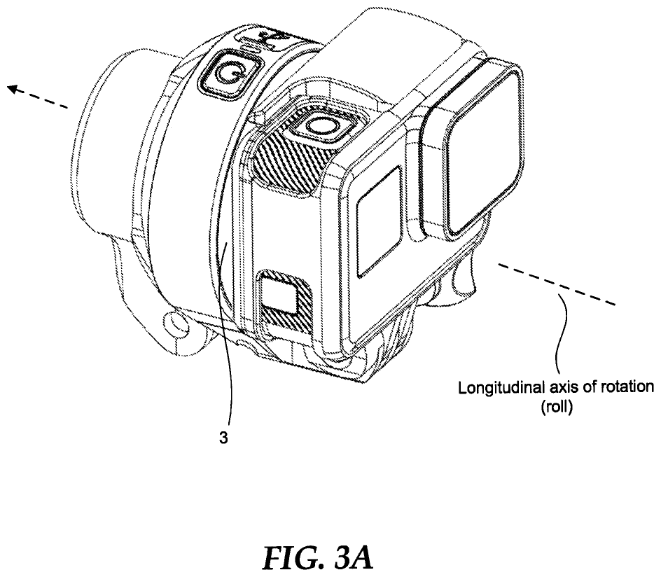

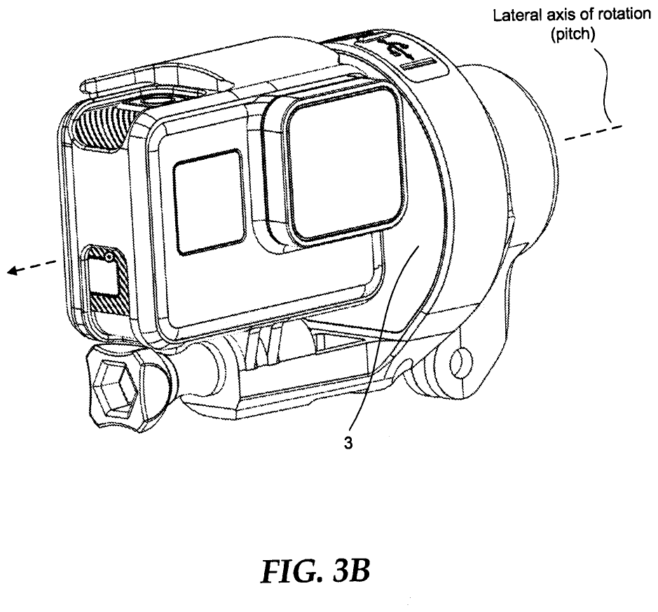

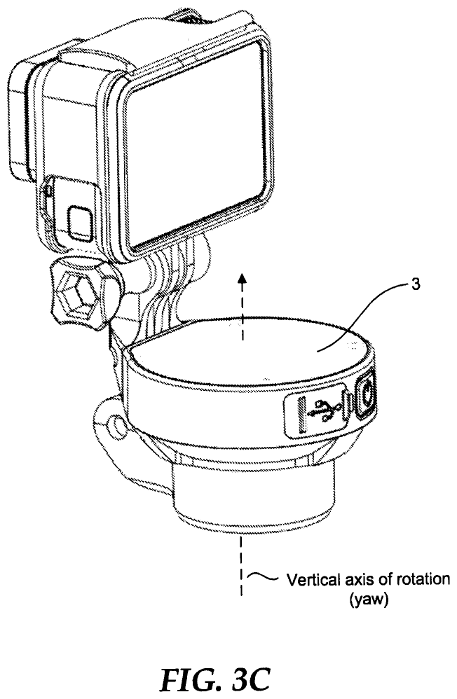

FIGS. 3A-C illustrate three configurations in which an action camera is mounted to stabilizer 1 in such a way as to enable stabilizer 1 to stabilize the action camera in one axis.

FIG. 3A illustrates a configuration in which the back of an action camera is flush with front face 3. In this configuration, stabilizer 1 rotates around the longitudinal axis of rotation of the action camera to stabilize the camera in the roll or longitudinal axis. The corrective movement performed by stabilizer 1 stabilizes the camera in regard to rolling movements.

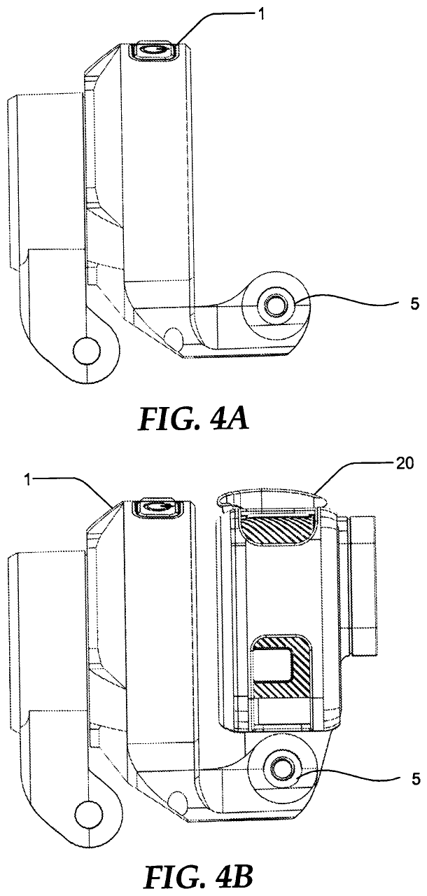

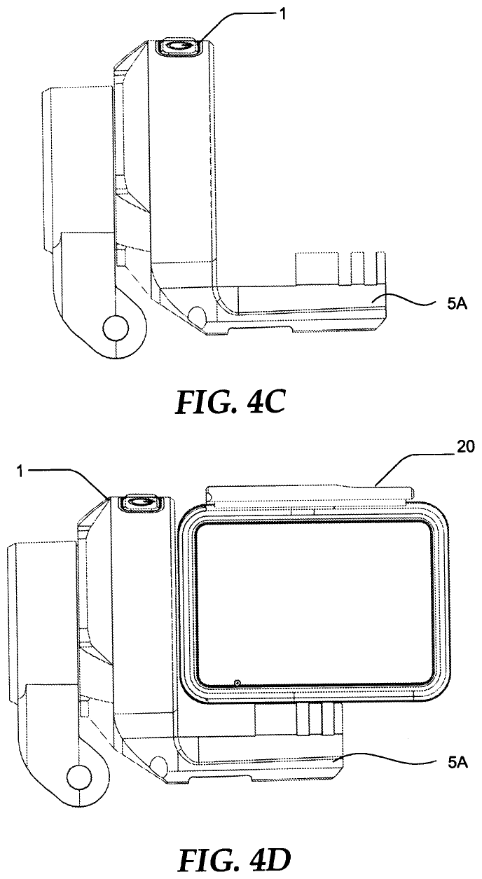

FIG. 3B illustrates a configuration in which one side of an action camera is flush with front face 3. In this configuration, stabilizer 1 rotates around the lateral axis of rotation of the action camera to stabilize the camera in the pitch or lateral axis. The corrective movement performed by stabilizer 1 stabilizes the camera with respect to pitching movements. As illustrated in FIGS. 4A-4D, a different camera mount may be used to achieve the mounting configuration illustrated in FIG. 3B. In other embodiments, an adapter may be used with camera mount 5 to achieve the necessary connection.

FIG. 3C illustrates a configuration in which the bottom of an action camera is parallel with front face 3. Another way to describe the geometric relationship is that the plane formed by the back of the action camera is perpendicular to the plane formed by front face 3. In this configuration, stabilizer 1 rotates around the vertical axis of rotation of the action camera to stabilize the camera in the yaw or vertical axis. The corrective movement performed by stabilizer 1 stabilizes the camera in regard to yaw rotations, i.e. movements to the left or right of the direction of motion.

It may be appreciated that camera mount 5 may vary for each of the configurations illustrated in FIGS. 3A-C. Specifically, in one embodiment, as illustrated in FIGS. 4A-D, one camera, mount 5 is used for the configurations illustrated in FIGS. 3A and 3C while a different camera mount is used for configuration illustrated in FIG. 3B.

FIGS. 4A and 4B illustrate stabilizer 1 with camera mount 5 that is configured to stabilize a camera in the roll axis (as illustrated in FIG. 3A). FIG. 4B illustrates stabilizer 1 with camera 20 attached via camera mount 5. Camera mount 5 is also suitable for stabilizing a camera in the yaw dimension, as illustrated in FIG. 3C.

FIGS. 4C and 4D illustrate stabilizer 1 with a modified camera mount 5A that is configured to stabilize a camera in the pitch axis (as illustrated in FIG. 3B). FIG. 4D illustrates stabilizer 1 with camera 20 attached via camera mount 5A. The only difference between camera mount 5 and camera mount 5A is that the male connecting portion, i.e., the vertical prongs, of camera mount 5A is turned 90 degrees with respect to those of camera mount 5. In another embodiment, an adapter can be provided for camera mount 5 that provides a male connecting portion with the desired rotation rather than providing a separate camera mount.

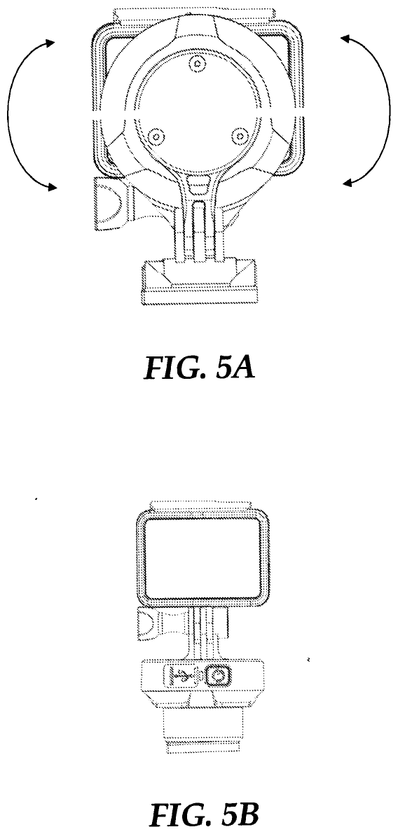

FIGS. 5A-B illustrate two modes provided by the stabilizer, a stabilization mode and a moving time-lapse mode. Using control 4 a user can select between the two different modes of operation, as described in Table 1 below. FIG. 5A illustrates the action of stabilizer 1 when in stabilization mode. It depicts the rear of stabilizer 1 mounted to an action camera in the roll (FIG. 3A) configuration. The horizontal line indicates that the action of stabilizer 1 is to move the camera to the right or left in order to maintain the action camera such that its left-to-right axis is parallel to the ground.

FIG. 5B illustrates the action of stabilizer 1 when in moving time-lapse mode. It depicts the back of the action camera, and the action camera mounted to stabilizer 1 in the yaw (FIG. 3C) configuration. After selecting moving time-laps mode, the user then defines an exit (stopping) point or angle and an entry (starting) point or angle. Next the user can define a time interval over which to sweep the camera from the entry to the exit point. Next the user initiates the capture sequence and stabilizer 1 moves the action camera smoothly from the entry angle to the exit angle ever the defined time period. This is referred to as a moving time-lapse in standard time-lapse photography the direction of the camera doesn't change. After the stabilizer moves from the entry angle to the exit angle it returns to a ready state or turns off.

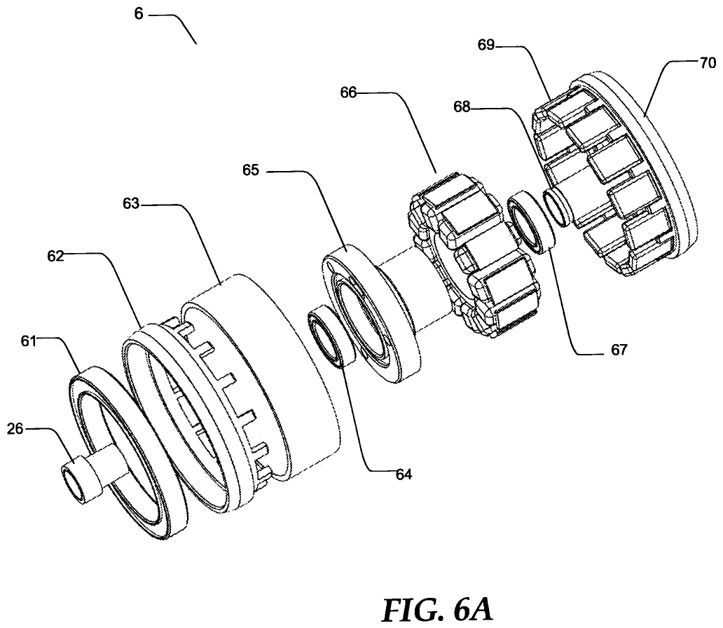

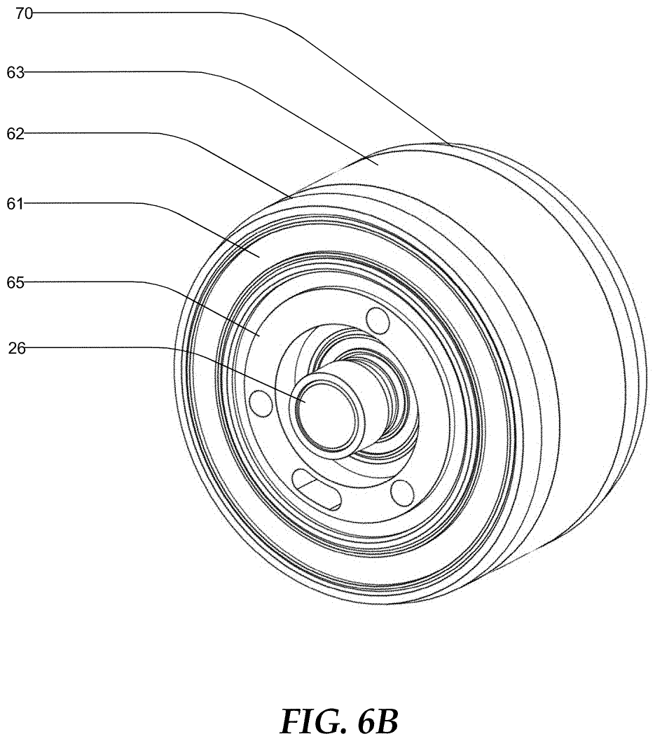

FIGS. 6A-6B provide further detail regarding the design and operation of motor 6.

FIG. 6A is an exploded view of one embodiment of the components of motor 6. Moving right to left through the figure, a rotor 69 attaches to a back plate 70. Back plate 70 connects to removeable stabilizer mount 7 (not depicted in FIG. 6A). In normal operation, stabilizer mount 7 connects to a user or to an item of configuration and is thus maintained in a stationary position in relation to the user or to the item of equipment. Thus, if the user or item or equipment rolls, pitches or yaws, so does the back assembly, which includes of rotor 69, back plate 70 and stabilizer mount 7.

Rotor 69 includes a number of fixed magnets arranged cylindrically around a shaft which defines a longitudinal axis for motor 6 and stabilizer 1. Although shaft 68 appears truncated, in fact it runs the longitudinal length of motor 6.

Motor 6 includes 3 bearings, outer bearing 61 and inner bearings 64 and 67, that rotate around shaft 68. A stator 66 with a plurality of coils is mounted against a stator mount 65 and turns along with inner bearings 64 and 67. An outer ring 62 and flux ring 63 fit against rotor 69 and form a waterproof outer housing for motor 6. Stator mount 65 connects to back enclosure 23 and transmits the rotational energy of motor 6 to enclosure 2 and hence camera 20 is camera mount 5.

Generally, rotor 69 and stator 66 exert rotational three against each other. Since, rotor 69 is attached to back plate 70 which in turn is anchored, via stabilizer mount 7 (not depicted in FIG. 6A), to a user or to an item of equipment, this results in stator 66 together with the three bearings rotating around shaft 68. Motor 6 is entirely closed, as part of the general waterproof design of stabilizer 1, hence the rotation of motor 6 is transmitted to an attached action camera through stator mount 65 which attaches to back enclosure 23. The amount of rotation of motor 6 is controlled by the processor on PCBA 24. As previously discussed it moves in opposition to the movement of the user or device to which stabilizer mount 7 is anchored or attached.

FIG. 6B is an isometric view of one embodiment of motor 6. As illustrated, back plate 70, flux ring 63 and outer ring 61 form an enclosure for motor 6. Rotational motion is transmitted through the attachment between stator mount 65, which rotates along with stator 66 on the three bearings, and back enclosure 23. As indicated in FIG. 6B, stator mount 65 and back enclosure 23 wire attached by three screws. Note that FIG. 6B illustrates the three screw holes but not the screws themselves.

In the embodiments illustrated in FIGS. 6A-6B, motor 6 has an outer rotor design where the rotor, the moving element, is an outer cylinder that incorporates permanent magnets and the stator fits inside the outer cylinder. Further, motor 6 is a closed, DC, brushless motor. The motor is waterproof and includes 3 bearings.

### User Commands

Table 1, below, provides one embodiment of a set of user commands that may he issued by a user and acted upon by stabilizer 1. Each command is made by pressing or clicking control 4 as indicated. Additional or different commands may be available without departing from the spirit or scope of the subject invention.

TABLE 1
User Commands

| User Command | Effect |
|---|---|
| 1 long press (>1 second) | Turn device on and off |
| The following commands | |
| only operate when | |
| the device is turned on: | |
| 1 click | Set to Roll & pitch stabilization |
| | mode |
| 2 clicks | Set to Yaw stabilization mode |
| 3 clicks | Set to Moving time-lapse mode |
| 4 clicks | Set duration of moving time-lapse to |
| | 30 min |
| 5 clicks | Set duration of moving time-lapse to |
| | 60 min |

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A camera stabilization system comprising:
(a) a camera mount;
(b) a stabilizer;
(c) a stabilizer mount;
(d) a USB interface;
(e) a battery;
(f) a motor;
(g) a transitory memory;
(h) a microprocessor;
(i) a control button; and
(i) a single electric motor.

2. The camera mount of claim 1 being configured to receive popular action cameras thereon.

3. The stabilizer mount of claim 1 being disposed to receive popular body part anchors thereto.

4. The USB interface of claim 1 being connected to the onboard battery.

5. The control button being connected to the battery and the microprocessor.

6. A method for stabilizing cameras. The method comprising:
(a) securing an action camera on multiple axis;
(b) stabilizing roll pitch and yaw;
(c) preventing water intrusion;
(d) programming stabilizer start and stop angles;
(e) mounting a camera on body part and tripod anchors.

7. The stabilizing roll, pitch and yaw of claim 5 wherein roll, pitch and yaw are stabilized individually as determined by a user.
